(19) United States
(12) Patent Application Publication
(10) Pub. No.: US 2016/0378512 A1
(43) Pub. Date: Dec. 29, 2016

(54) CIRCUIT, METHOD, AND DEVICE FOR WAKING UP MASTER MCU

(71) Applicant: Xiaomi Inc., Beijing (CN)

(72) Inventors: Deguo MENG, Beijing (CN); Yi DING, Beijing (CN); Enxing Hou, Beijing (CN)

(73) Assignee: Xiaomi Inc.

(21) Appl. No.: 15/132,301

(22) Filed: Apr. 19, 2016

(30) Foreign Application Priority Data
Jun. 29, 2015 (CN) 201510370154.4

(51) Int. Cl. G06F 9/44; G06F 1/32; G06F 13/24; G06F 13/364; G06F 13/42

(52) U.S. Cl. CPC G06F 9/4418; G06F 13/364; G06F 13/4291; G06F 13/24; G06F 1/3243

(57) ABSTRACT

The present disclosure relates to a circuit that includes: a master microcontroller unit (MCU) having a clock line connected with a master clock signal; a peripheral interface chip; and a peripheral processing chip connected to the master MCU via the peripheral interface chip, wherein each of a clock line of the peripheral processing chip and a clock line of the peripheral interface chip is connected with a slave clock signal; wherein the peripheral processing chip is configured to remain working normally after the master MCU enters a deep sleep mode; and wherein the peripheral interface chip is configured to: remain working normally after the master MCU enters the deep sleep mode; monitor an amount of data sent by the peripheral processing chip to the peripheral interface chip; and send a wake-up signal to the master MCU when the amount of the data exceeds a threshold.

### CROSS-REFERENCE TO RELATED APPLICATIONS

This application is based upon and claims priority to Chinese Patent Application No. 201510370154.4, filed Jun. 29, 2015, the entire content of which is incorporated herein by reference.

### TECHNICAL FIELD

The present disclosure generally relates to the field of device technology and, more particularly, to a circuit, a method, and a device for waking up a master microcontroller unit (MCU).

### BACKGROUND

To reduce the power consumption of an embedded system, software developers often enable the system to switch into a low power-consumption mode when the system is idling. In such mode, an MCU chip enters a sleep mode or even a deep sleep mode. In the deep sleep mode, common peripherals of the MCU, such as the serial peripheral interface (SPI), the universal asynchronous receiver transmitter (UART) unit, and the analog/digital (A/D) converter unit, may not work properly. Therefore, other chips may not communicate with the MCU via the serial interface. Generally, only an external interrupt and/or a timer interrupt can wake up the MCU.

In addition, when used in a smart device, the MCU may also be configured to enter a sleep mode or a deep sleep (for example, standby/hibernate) mode to save energy, when the smart device is idling. In the deep sleep mode, the master clock stops working, and some inner peripherals of the smart device, such as the UART unit, the SPI unit, the inter-integrated circuit bus (I2C) unit, the AID unit, and the pulse width modulation (PWM) unit, may also not be able to work if these inner peripherals' operations depend on the master clock. Thus, the MCU may not timely receive data sent from the UART unit, the SPI unit, the I2C unit, etc.

### SUMMARY

According to a first aspect of the present disclosure, there is provided a circuit, comprising: a master microcontroller unit (MCU); a peripheral interface chip; and a peripheral processing chip connected to the master MCU via the peripheral interface chip, wherein a clock line of the master MCU is connected with a master clock signal, and each of a clock line of the peripheral processing chip and a clock line of the peripheral interface chip is connected with a slave clock signal; wherein the peripheral processing chip is configured to remain working normally after the master MCU enters a deep sleep mode; and wherein the peripheral interface chip is configured to: remain working normally after the master MCU enters the deep sleep mode; monitor an amount of data sent by the peripheral processing chip to the peripheral interface chip; and send a wake-up signal to the master MCU when the amount of the data exceeds a threshold.

According to a second aspect of the present disclosure, there is provided a method for use in an apparatus comprising a master microcontroller unit (MCU), a peripheral interface chip, and a peripheral processing chip, the method comprising: controlling the master MCU to enter a deep sleep mode, and controlling the peripheral interface chip and the peripheral processing chip to work normally; monitoring an amount of data sent by the peripheral processing chip to the peripheral interface chip; and when the amount of the data exceeds a threshold, sending a wake-up signal to the master MCU.

According to a third aspect of the present disclosure, there is provided a device for waking up a master microcontroller unit (MCU), comprising: a processor; and a memory configured to store instructions executable by the processor; wherein the processor is configured to: control the master MCU to enter a deep sleep mode, and control a peripheral interface chip and a peripheral processing chip to work normally; monitor an amount of data sent by the peripheral processing chip to the peripheral interface chip; and send a wake-up signal to the master MCU when the amount of the data exceeds a threshold.

It is to be understood that both the foregoing general description and following detail description are exemplary and explanatory only and shall not be construed to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a circuit for waking up a master MCU, according to an exemplary embodiment.

FIG. 2 is a flowchart of a method for waking up a master MCU, according to an exemplary embodiment.

FIG. 3 is a flowchart illustrating a step in a method for waking up a master MCU, according to an exemplary embodiment.

FIG. 4 is a block diagram of a device for waking up a master MCU, according to an exemplary embodiment.

FIG. 5 is a block diagram of a configuring module in a device for waking up a master MCU, according to an exemplary embodiment.

FIG. 6 is a block diagram of a device for waking up a master MCU, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

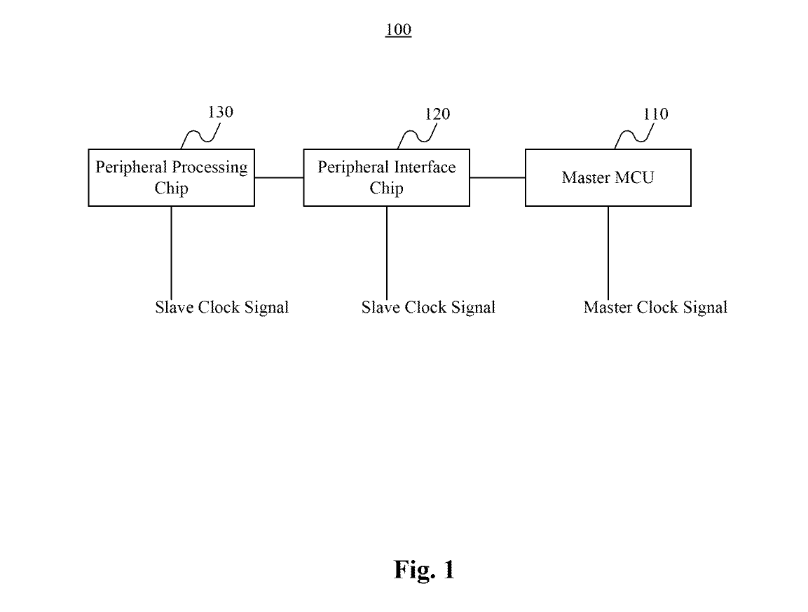

FIG. 1 is a schematic diagram illustrating a circuit 100 for waking up a master MCU, according to an exemplary embodiment. Referring to FIG. 1, the circuit 100 includes a master MCU 110, a peripheral interface chip 120, and a peripheral processing chip 130. The peripheral processing chip 130 is connected to the master MCU 110 via the peripheral interface chip 120.

In exemplar embodiments, a clock line of the master MCU 110 is connected to a master clock signal. Moreover, each of a clock line of the peripheral interface chip 120 and a clock line of the peripheral processing chip 130 is connected to a slave clock signal. That is, the clock line of the master MCU 110, and the clock lines of the peripheral interface chip 120 and the peripheral processing chip 130 are connected to different clock signals. This way, the peripheral interface chip 120 and the peripheral processing chip 130 may remain working normally while the master MCU enters a deep sleep mode.

Moreover, the peripheral interface chip 120 is configured to monitor an amount of data sent by the peripheral processing chip 130 to the peripheral interface chip 120, and to send a wake-up signal to the master MCU 110 when the amount of the data exceeds a threshold. This way, the master MCU 110 originally in the deep sleep mode may be timely woken up to send, receive, and process data.

In one exemplary embodiment, a buffer may be disposed in the peripheral interface chip 120. For the peripheral processing chip 130 to send data to the master MCU 110 via the peripheral interface chip 120, the peripheral processing chip 130 first sends the data to the peripheral interface chip 120. The peripheral interface chip 120 stores the received data in the buffer and then sends the wake-up signal to the master MCU when the amount of the data exceeds then the threshold.

In one exemplary embodiment, the peripheral interface chip 120 sends the wake-up signal in a form of an interrupt. Specifically, the peripheral interface chip 120 monitors the amount of the data sent by the peripheral processing chip 130 to the peripheral interface chip 120, and generates the interrupt when the amount of the data exceeds the threshold. The peripheral interface chip 120 then sends the interrupt to the master MCU 110 to wake up the master MCU 110.

In one exemplary embodiment, the peripheral processing chip 130 and the peripheral interface chip 120 may transmit data between each other via direct memory access (DMA). DMA is a high-speed data transfer operation that allows direct data reading and writing between an external device and a memory, without being conducted via a CPU or needing any intervention by the CPU. DMA can be entirely controlled by a DMA controller, such that data may be transmitted between the peripheral processing chip 130 and the peripheral interface chip 120 even if the master MCU is in the deep sleep mode.

In some exemplary embodiments, the peripheral interface chip 120 may include one or more of a UART unit, a SPI unit, an I2C unit, or a Bluetooth unit. Moreover, the peripheral processing chip 130 may include one or more of an A/D unit, a PWM unit, a video processing unit, or an audio processing unit.

In the following, an application example of the circuit 100 is described. For illustrative purpose only, the peripheral interface chip 120 is configured as the UART unit, and the peripheral processing chip 130 is configured as the A/D unit. The circuit 100 may be implemented as a low power-consumption circuit in a smart device. The master MCU 110 in the circuit 100 may be timely woken up from a deep sleep mode to receive and send data. The circuit 100 may have an internal peripheral structure independent of a master clock, in which the internal peripherals, such as the UART unit and A/D unit, have their own work clocks independent of the master clock. Thus, when the master MCU 110 enters the deep sleep mode, the working state of an internal peripheral may be configured separately. For example, the UART unit may remain in a normal working state even when the master MCU 110 enters the deep sleep mode, and exchange data with the AID unit via DMA. When an amount of the data sent by the AID unit to the UART unit exceeds a threshold, the UART unit may wake up the master MCU 110 by sending an interrupt to the master MCU 110, such that the master MCU 110 may receive, send, and process data. In this manner, the circuit 100 may ensure that the smart device in an ultra-low power-consumption mode still receives data normally.

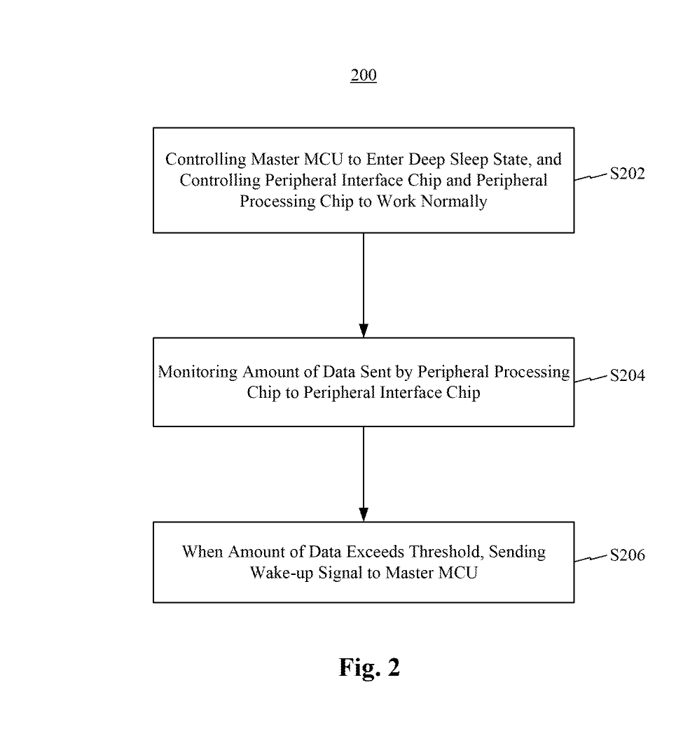

FIG. 2 is a flowchart of a method 200 for waking up a master MCU, according to an exemplary embodiment. For example, the method 200 may be used in an apparatus including the master MCU, a peripheral interface chip, and a peripheral processing chip. Referring to FIG. 2, the method 200 includes the following steps S202-S206.

In step S202, the master MCU is controlled to enter a deep sleep mode, and the peripheral interface chip and the peripheral processing chip are controlled to work normally.

In step S204, an amount of data sent by the peripheral processing chip to the peripheral interface chip is monitored.

In step S206, when the amount of the data exceeds a threshold, a wake-up signal is sent to the master MCU. The wakeup signal may be in a form of an interrupt.

According to the method 200, the master MCU may be timely woken up from the deep sleep mode to receive and send data.

In some exemplary embodiments, the peripheral interface chip may include one or more of a UART unit, a SPI unit, an I2C unit, or a Bluetooth unit. Moreover, the peripheral processing chip may include one or more of an A/D unit, a PWM unit, a video processing unit, or an audio processing unit.

In one exemplary embodiment, step S202 may further include: the peripheral processing chip and the peripheral interface chip are controlled to transmit data between each other via DMA.

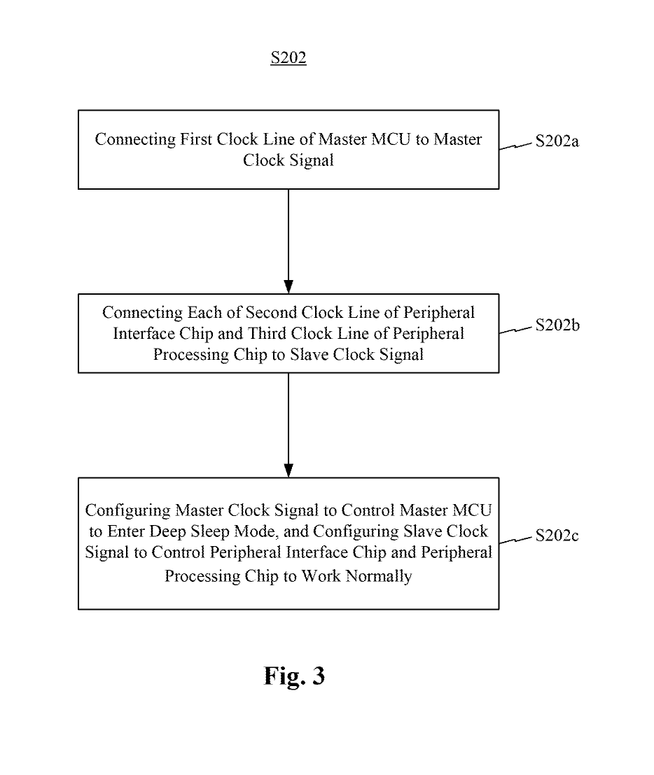

FIG. 3 is a flowchart illustrating step S202 in the method 200 (FIG. 2) for waking up a master MCU, according to an exemplary embodiment. As shown in FIG. 3, step S202 includes the following sup-steps.

In sub-step S202a, a clock line of the master MCU is connected to a master clock signal.

In sub-step S202b, each of a clock line of the peripheral interface chip and a clock line of the peripheral processing chip is connected to a slave clock signal.

In sub-step S202c, the master clock signal is configured to control the master MCU to enter the deep sleep mode, and the slave clock signal is configured to control the peripheral interface chip and the peripheral processing chip to work normally.

In the above-described step S202, the clock line of the master MCU and the clock lines of the peripheral interface chip and the peripheral processing chip are connected to different clock signals, respectively. Therefore, the peripheral interface chip and the peripheral processing chip may remain working normally while the master MCU enters a deep sleep state.

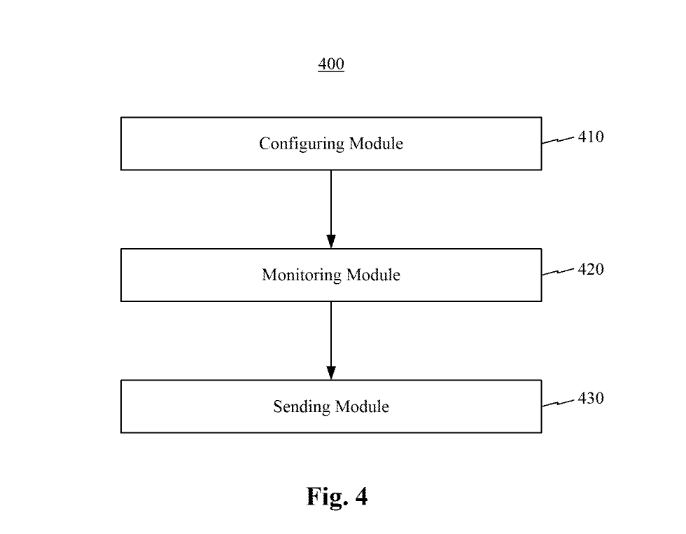

FIG. 4 is a block diagram of a device 400 for waking up a master MCU, according to an exemplary embodiment. For example, the device 400 may be used in an apparatus including the master MCU, a peripheral interface chip, and a peripheral processing chip. Referring to FIG. 4, the device 400 includes a configuring module 410, a monitoring module 420, and a sending module 430.

The configuring module 410 is configured to control the master MCU to enter a deep sleep mode, and control the peripheral interface chip and the peripheral processing chip to work normally.

The monitoring module 420 is configured to monitor an amount of data sent by the peripheral processing chip to the peripheral interface chip.

The sending module 430 is configured to send a wake-up signal to the master MCU when the amount of the data exceeds a threshold.

By sending the wake-up signal to the master MCU when the amount of the data sent from the peripheral processing chip to the peripheral interface chip exceeds the threshold, the device 400 may timely wake up the master MCU from the deep sleep state to receive and send data.

In one exemplary embodiment, the configuring module 410 is further configured to control the peripheral interface chip and the processing interface chip to transmit data between each other via DMA.

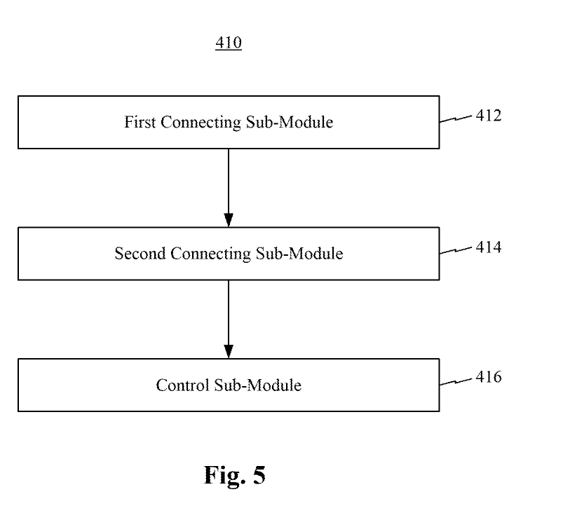

FIG. 5 is a block diagram of the configuring module 410 (FIG. 4), according to an exemplary embodiment. As shown in FIG. 5, the configuring module 410 includes a first connecting sub-module 412, a second connecting sub-module 414, and a control sub-module 416.

The first connecting sub-module 412 is configured to connect a clock line of the master MCU to a master clock signal.

The second connecting sub-module 414 is configured to connect each of a clock line of the peripheral interface chip and a clock line of the peripheral processing chip to a slave clock signal.

The control sub-module 416 is configured to configure the master clock signal to control the master MCU to enter the deep sleep mode, and configure the slave clock signal to control the peripheral interface chip and the peripheral processing chip to work normally.

By connecting the clock line of the master MCU, and the clock lines of the peripheral processing chip and the peripheral interface chip to different clock signals, respectively, the configuring module 410 may control the peripheral interface chip and the peripheral processing chip to remain working normally, whereas control the master MCU to enter a deep sleep mode.

In some exemplary embodiments, the peripheral interface chip may include one or more of a UART unit, a SPI unit, an I2C unit, or a Bluetooth unit.

In some exemplary embodiments, the peripheral processing chip may include more or more of an A/D unit, a PWM unit, a video processing unit, or an audio processing unit.

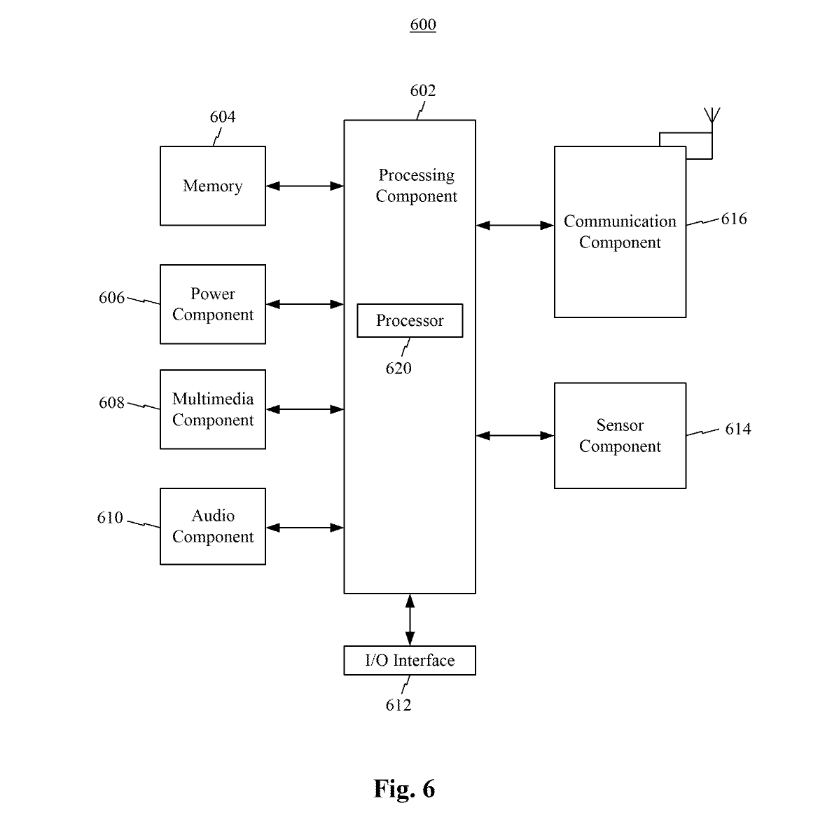

FIG. 6 is a block diagram of a device 600 using the above described methods for waking up a master MCU, according to an exemplary embodiment. For example, the device 600 may be a mobile phone, a computer, a digital broadcasting terminal, a messaging device, a gaming console, a tablet, exercise equipment, a personal digital assistant (PDA), etc.

Referring to FIG. 6, the device 600 may include one or more of the following components: a processing component 602, a memory 604, a power component 606, a multimedia component 608, an audio component 610, an Input/Output (1/0) interface 612, a sensor component 614, and a communication component 616. In addition, the device 600 may include a master MCU, a peripheral interface chip, and a peripheral processing chip.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 608 includes a front camera and/or a rear camera. The front camera and the rear camera may receive external multimedia data while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface for the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600 and relative positioning of components (e.g. the display and the keypad of the device 600). The sensor component 614 may also detect a change in position of the device 600 or of a component in the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate wired or wireless communication between the device 600 and other devices. The device 600 can access a wireless network based on a communication standard, such as WIFI, 2G, 3G, 4G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as the memory 604 including instructions. The above instructions are executable by the processor 620 in the device 600, for performing the above-described methods. For example, the non-transitory computer-readable storage medium may be a read-only memory (ROM), a random access memory (RAM), a CD-ROM, a magnetic tape, a floppy disc, an optical data storage device, and the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the present disclosure will be apparent to those skilled in the art from consideration of the specification and practice of the present disclosure. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact constructions that are described above and illustrated in the accompanying drawings, and that various modifications and changes can be made without departing from the scope thereof. It is intended that the scope of the invention only be limited by the appended claims.

What is claimed is:

1. A circuit, comprising:
a master microcontroller unit (MCU);
a peripheral interface chip; and
a peripheral processing chip connected to the master MCU via the peripheral interface chip,
wherein a clock line of the master MCU is connected with a master clock signal, and each of a clock line of the peripheral processing chip and a clock line of the peripheral interface chip is connected with a slave clock signal;
wherein the peripheral processing chip is configured to remain working normally after the master MCU enters a deep sleep mode; and
wherein the peripheral interface chip is configured to:
remain working normally after the master MCU enters the deep sleep mode;
monitor an amount of data sent by the peripheral processing chip to the peripheral interface chip; and
send a wake-up signal to the master MCU when the amount of the data exceeds a threshold.

2. The circuit according to claim 1, wherein the wake-up signal is in a form of an interrupt.

3. The circuit according to claim 1, wherein, when the peripheral interface chip and the peripheral processing chip remain working normally, each of the peripheral interface chip and the peripheral processing chip is configured to:
transmit data between the peripheral interface chip and the processing interface chip via direct memory access (DMA).

4. The circuit according to claim 1, wherein the peripheral interface chip includes at least one of a universal asynchronous receiver transmitter (UART) unit, a serial peripheral interface (SPI) unit, an inter-integrated circuit bus (I2C) unit, or a Bluetooth unit.

5. The circuit according to claim 1, wherein the peripheral processing chip includes at least one of an analog/digital (A/D) unit, a pulse width modulation (PWM) unit, a video processing unit, or an audio processing unit.

6. The circuit according to claim 1, wherein:
the peripheral interface chip includes a buffer configured to store the data sent by the peripheral processing chip; and
the peripheral interface chip is further configured to monitor whether the amount of the data stored in the buffer exceeds the threshold.

7. A method for use in an apparatus comprising a master microcontroller unit (MCU), a peripheral interface chip, and a peripheral processing chip, the method comprising:
controlling the master MCU to enter a deep sleep mode, and controlling the peripheral interface chip and the peripheral processing chip to work normally;
monitoring an amount of data sent by the peripheral processing chip to the peripheral interface chip; and
when the amount of the data exceeds a threshold, sending a wake-up signal to the master MCU.

8. The method according to claim 7, wherein the sending of the wake-up signal to the master MCU further comprises:
sending the wake-up signal in a form of an interrupt.

9. The method according to claim 7, wherein the controlling of the master MCU to enter the deep sleep mode and the controlling of the peripheral interface chip and the peripheral processing chip to work normally further comprise:
connecting a clock line of the master MCU to a master clock signal;
connecting each of a clock line of the peripheral interface chip and a clock line of the peripheral interface chip to a slave clock signal;
configuring the master clock signal to control the master MCU to enter the deep sleep mode; and
configuring the slave clock signal to control the peripheral interface chip and the peripheral processing chip to work normally.

10. The method according to claim 7, wherein the controlling of the peripheral interface chip and the peripheral processing chip to work normally further comprises:
controlling the peripheral interface chip and the peripheral processing chip to transmit data between each other via direct memory access (DMA).

11. The method according to claim 7, wherein the peripheral interface chip includes at least one of a universal asynchronous receiver transmitter (UART) unit, a serial peripheral interface (SPI) unit, an inter-integrated circuit bus (I2C) unit, or a Bluetooth unit.

12. The method according to claim 7, wherein the peripheral processing chip includes at least one of an analog/digital (A/D) unit, a pulse width modulation (PWM) unit, a video processing unit, or an audio processing unit.

13. The method according to claim 7, wherein the peripheral interface chip includes a buffer, and the monitoring of the amount of data sent by the peripheral processing chip to the peripheral interface chip further comprises:
storing the data sent by the peripheral processing chip in the buffer; and
monitoring whether the amount of the data stored in the buffer exceeds the threshold.

14. A device for waking up a master microcontroller unit (MCU), comprising:
a processor; and
a memory configured to store instructions executable by the processor;
wherein the processor is configured to:
control the master MCU to enter a deep sleep mode, and control a peripheral interface chip and a peripheral processing chip to work normally;
monitor an amount of data sent by the peripheral processing chip to the peripheral interface chip; and
send a wake-up signal to the master MCU when the amount of the data exceeds a threshold.

15. The device according to claim 14, wherein the processor is further configured to: send the wake-up signal in a form of an interrupt.

16. The device according to claim 14, wherein the processor is further configured to:
connect a clock line of the master MCU to a master clock signal;
connect each of a clock line of the peripheral interface chip and a clock line of the peripheral interface chip to a slave clock signal;
configure the master clock signal to control the master MCU to enter the deep sleep state; and
configure the slave clock signal to control the peripheral interface chip and the peripheral processing chip to work normally.

17. The device according to claim 14, wherein the processor is further configured to:
control the peripheral interface chip and the peripheral processing chip to transmit data between each other via direct memory access (DMA).

18. The device according to claim 14, wherein the peripheral interface chip includes at least one of a universal asynchronous receiver transmitter (UART) unit, a serial peripheral interface (SPI) unit, an inter-integrated circuit bus (I2C) unit, or a Bluetooth unit.

19. The device according to claim 14, wherein the peripheral processing chip includes at least one of an analog/digital (A/D) unit, a pulse width modulation (PWM) unit, a video processing unit, or an audio processing unit.

20. The device according to claim 14, wherein the peripheral interface chip includes a buffer configured to store the data sent by the peripheral processing chip, and the processor is further configured to:
monitor whether the amount of the data stored in the buffer exceeds the threshold.
